(19) United States
(12) Patent Application Publication
(10) Pub. No.: US 2006/0275037 A1
(43) Pub. Date: Dec. 7, 2006

(54) Methods and apparatus for multiple signal amplification

(76) Inventors: Alan F. Evans, Beaver Dams, NY (US); Alranzo B. Ruffin, Painted Post, NY (US); Donnell J. Walton, Palnted Post, NY (US)

Correspondence Address: CORNING CABLE SYSTEMS LLC, P O BOX 489, HICKORY, NC, 28603, US

(21) Appl. No.: 11/142,919

(22) Filed: Jun. 2, 2005

(51) Int. Cl. H04J 14/00

(52) U.S. Cl. 398/71

(57) ABSTRACT

An apparatus for multiple signal amplification in a passive optical network, includes a remotely-pumped, single erbium coil positioned intermediate a central office and a split point in the network, wherein both analog and digital signals transmitted within an erbium coil amplification band from the central office and one or more subscriber premises pass through the erbium coil and are amplified prior to being split at the split point.

### CROSS-REFERENCE TO RELATED APPLICATIONS

This application is related to U.S. patent application entitled “METHODS AND APPARATUS FOR SELECTIVE SIGNAL AMPLIFICATION” filed contemporaneously, the description of which is herein incorporated by reference.

### BACKGROUND OF THE INVENTION

1. Field of the Invention

The present invention relates generally to a passive optical network, and more specifically, to a passive optical network including an amplifying method and apparatus for C-band signal amplification.

2. Technical Background

Passive optical networks (PONS) are used to provide high-bandwidth information to and from an end user or subscriber of a metropolitan area network. Typically, PONs are fiber-based, tree architecture networks with one or two levels of passive splitting providing a total split ratio up to thirty-two, which provides for some cost sharing of the expensive broadcast and digital downstream equipment. Existing PONs have about a 20 km reach with dedicated fiber drops to every subscriber premises, shared TDMA (timed division multiple access) upstream at a different wavelength, and, by definition, no electrical power in the outside fiber plant. While PONs are in use, they have not been widely commercially deployed because of the high cost per subscriber and the low rate of return for the telecommunications service provider or carrier. Based on increases in demand for high bandwidth and interactive services over bi-directional links, there is a renewed interest in PONs from telecommunications service providers for multiple reasons. First, new applications such as file sharing and software downloads require much higher connection speeds than the current digital subscriber line (DSL) technology can provide. Second, there is strong competition for services from cable television (CATV) companies, which already have a majority of the broadcast TV market and offer similar quality internet connections and telephony services. For telecommunications service providers to remain competitive, it would be desirable to provide a technology and a network that can surpass the bandwidth of CATV's hybrid fiber-coax to provide a subscriber with all desired services, some of which include TV, POTS (plain old telephone service) and internet connection.

Fiber-to-the-home (FTTH), fiber-to-the-business (FTTB) and fiber-to-the-premises (FTTP), referred to generically as FTTx, is just such a technology. Telecommunication service providers are attempting to standardize a FTTx PON solution to drive equipment prices to levels that offer an acceptable return on investment. Current subscriber equipment costs are in the thousands of dollars even with the 32-way sharing from single or two-stage splitting. The present invention addresses the sharing of costs issue by considering outside-plant amplification without outside-plant electrical powering. Amplification improves the total optical power loss in a system, referred to as the “loss budget”, and allows additional splitting and/or increased transmission distance, thereby distributing more of the infrastructure costs, especially the head end electronics and optics, over more subscribers. With the existing distribution of central offices (COs), increased distance may not be required, but consolidating several COs into one increases the typical transmission distance while improving equipment utilization especially important at low penetration rates.

Various modes of amplification in PONs have previously been proposed and are known in the literature. However, a mode of amplification is needed that lowers the amplification costs to improve the cost savings from additional equipment sharing. The current full service access network standard (FSAN) specifies the analog downstream between 1550 and 1560 nanometers (nm), the digital downstream between 1480 and 1490 nm and the digital upstream between 1260 and 1360 nm. Moving either or both digital signals into the erbium amplifier band would reduce amplifier costs because the additional components to amplify these signals are minimal. Further, moving either or both digital signals in to the C-band would allow the use of an erbium coil to amplify analog and digital downstream signals passing in a first direction through the coil and upstream digital signals passing in the opposite direction, i.e., bi-directional amplification with improved cost savings. A PON including a remotely-pumped amplifying apparatus would increase the split rate and/or the reach of the optical network, and would promote the installation of more fiber and PONs with reduced costs per subscriber.

### SUMMARY OF THE INVENTION

The present invention provides methods and apparatus employed in a passive optical network (PON), whereby multiple signals transmitted in the C-band pass through a remotely-pumped single coil of erbium for amplification prior to a split point, in order to provide an increased split rate.

In one aspect, the methods and apparatus include a module containing a single coil of erbium whereby multiple signals pass through the coil from the CO/head end. The current full service access network standard specifies analog downstream between 1550 and 1560 nm, digital downstream between 1480 and 1490 nm and digital upstream between 1260 and 1360 nm. Either or both of the digital signals are moved into the erbium amplifier bandwidth such that the single coil of erbium is used to amplify both the analog and digital signals. In one embodiment, the erbium coil amplifies analog and digital downstream signals while two bandpass filters, one located at an input end of the module and one at the output end of the module redirect the digital upstream signal through an alternate path within the module, thus bypassing the erbium coil. In an alternative embodiment, the erbium coil amplifies analog and digital downstream signals passing in a first direction through the coil and also amplifies digital upstream signals passing in the opposite direction. Bandwidth is shifted from the FSAN standard bandwidths such that all signals are transmitted in the C-band (1530-1562 nm), with each signal occupying about 10 nm of bandwidth. Various components may be added to the module for increased functionality, such as a gain-flattening filter (GFF), a pass-through for the 1310 nm digital upstream and an isolator.

In another aspect, the present invention provides a PON including a 1480 nm pump located in a CO/head end and a module containing an erbium coil positioned immediately before an LCP splitter. The digital downstream and/or the digital upstream signals are moved into the erbium amplifier bandwidth such that the erbium coil may be used to amplify both the analog and digital signals. Pump efficiency and noise figures are improved by transmitting both the analog and digital signals in the C-band (1530 to 1562 nm), and further eliminates the need for semiconductor optical amplifiers (SOAs) used to amplify non-1550 nm signals. A separation of 20 nm between the analog and digital downstream signals minimizes costs by relaxing center wavelength tolerance and de-multiplexing filter design. The current FSAN standard specifies 1550 to 1560 nm for the analog downstream, leaving 1570 to 1580 nm or 1530 to 1540 nm for the digital downstream. The 10 nm immediately adjacent to the analog signal (either 1540 to 1550 nm or 1560 to 1570 nm) may be designated for the digital upstream. In one PON embodiment, the erbium coil amplifies analog and digital downstream signals while bandpass filters contained within the module redirect the digital upstream signal through an alternate path within the module. In another PON embodiment, the erbium coil amplifies the downstream analog signal and the digital signal in both directions, thus providing bi-rectional amplification. The PON may further include a wavelength division multiplexer/demultiplexer (WDM) system for combining multiple signals and one or more network access points (NAP) for providing fiber drops to a plurality of subscriber locations.

In yet another aspect, the present invention provides a single amplifying means for both digital and analog signals in a PON. Remote amplification in a PON allows the signal power to drop in the outside fiber plant before the gain is added, preferably just before the LCP splitter. The gain provided by the amplifying means adds to the power budget allowing increased loss from more optical splitting, more fiber or more connectors. Up to about 20 km from the CO/head end, the single amplifying means of the present invention increases the split rate to at least 1×128 from conventional split rates of 1×16 for subscribers out to 8 km from the CO/head end and 1×32 for subscribers between 8 to 20 km from the CO/head end. The required additional gain of about 7 dB is easily achieved with a remotely-pumped erbium coil.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof. Additionally, the drawings and descriptions are meant to be illustrative and not limiting.

### BRIEF DESCRIPTION OF THE DRAWINGS

FIG. 1 is a block diagram illustrating a portion of a PON including a module containing a single coil of erbium operable for providing gain to digital and analog signals passing through the coil.

FIG. 2 is a block diagram of a FTTx PON illustrating the location of a pump in the CO/head end and the location of the erbium coil immediately before the LCP splitter.

FIG. 3 is a block diagram illustrating a FTTx PON with 1×128 splits and a 20 km reach achieved using an erbium coil located before the LCP splitter to provide gain to the multiple signals.

FIG. 4 is a block diagram illustrating one embodiment of a pump sharing configuration in which a single high power pump is split between two PONs.

FIG. 5 is a block diagram illustrating an alternative embodiment of a pump sharing configuration in which two lower power pumps are shared between two PONs.

### DETAILED DESCRIPTION OF THE PREFERRED EMBODIMENTS

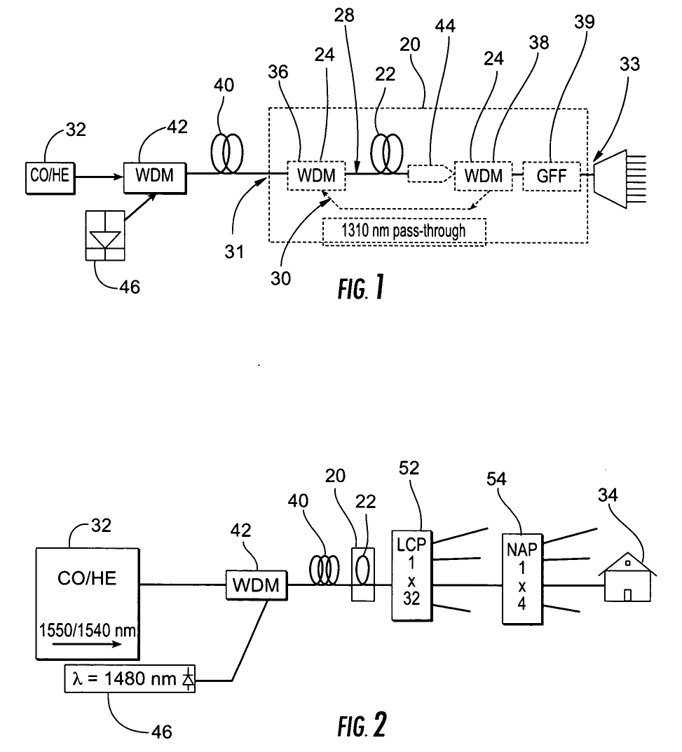

Reference will now be made in detail to the present preferred embodiments of the invention, and examples of which are illustrated in the accompanying drawings. Whenever possible, the same reference numerals will be used throughout the drawings to refer to the same or like parts. A module containing a coil of erbium for multiple signal amplification in a PON is shown in FIG. 1 and is designated generally throughout by reference number 20.

Throughout the detailed description, the current full service access network standard specifies analog downstream between 1550 and 1560 nm, digital downstream between 1480 and 1490 nm and digital upstream between 1260 and 1360 nm. The remotely-pumped erbium coil of the present invention provides signal amplification in the C-band (1530 to 1562 nm). The digital downstream and/or the digital upstream signals are moved into the erbium amplifier bandwidth to amplify both the analog and digital signals with the single coil of erbium.

Referring now to FIG. 1, an amplification/splitter module 20 containing a passive amplification element 22 and optional passive splitters 24 employed in a PON is shown. In one embodiment, passive amplification element 22 is a single coil of erbium and is sometimes referenced as single coil of erbium 22. As used herein, the term “passive amplification element” refers to all things capable of amplifying an optical signal without electricity such as a coil of erbium. Analog downstream and digital downstream signals originate from a Central Office (CO)/head end 32 and pass through the module 20 to the first split point in the network, such as an Local Convergence Point (LCP) splitter. A 1480 nm pump 46 provides remote amplification of the erbium coil 22 while avoiding stimulated Brillouin scattering (SBS) of the analog signal.

In a first module architecture embodiment, the module 20 includes both a first optical branch 28 and a second optical branch 30 for directing signals through the module 20. The first optical branch 28 includes the transmission optical fiber 40 and predetermined length of erbium coil 22, and directs the analog downstream and digital downstream signals through the module 20 and coil 22. The second optical branch 30 is a digital upstream pass-through and directs the digital upstream through an alternate path within the module 20, circumventing the erbium coil 20. The first and second optical branches 28, 30 are parallel in the sense that the analog and digital downstream signals pass through the first branch 28 while the digital upstream signals pass simultaneously through the second branch 30. Two bandpass optical filters 24, one located at the input end 31 and one located at the output end 33 of the module 20 direct the multiple signals through their appropriate branch.

The optical signals transmitted through the module 20 are separated at the first WDM 36 and later recombined after the erbium coil 22 by the second WDM 38. Various components may be added to the module 20 for increased functionality. Particularly, a gain-flattening filter (GFF) 39 may be added when the gain bandwidth is about 30 nm and is not sufficiently flat. An isolator 44 may added to the first optical branch 28 to protect the erbium coil 22 from reflections from customer premise equipment.

In a second module architecture embodiment, the second optical branch 30 and filters 24 are eliminated and the downstream analog and digital signals pass through the coil 22 in a first direction, and the digital upstream signal passes through the coil 22 in a second opposing direction, thus providing bi-directional amplification using a single erbium coil 22. The elimination of the second branch 30 includes the elimination of the first and second WDMs 36, 38, the GFF 39 and the isolator 44.

From the CO/head end 32 through the subscriber premises 34, the multiple signals are carried at their predetermined, various wavelengths of light through a single optical fiber 40, examples of which include, but are not limited to SMF-28®, HI 980 or HI 1060 single mode optical fibers available from Coming Cable Systems of Hickory, N.C. These particular fibers exhibit consistently low splice loss when coupled with an erbium-doped fiber. The PON further includes a WDM system 42 downstream of the CO/head end 32 including a series of transmitters each coupled to a multiplexer. The multiplexer provides an output that is coupled to the optical fiber 40. Although not shown, at the receiving end is typically a system that includes a demultiplexer and a series of receivers. The optical fiber 40 is also coupled to an input of the demultiplexer of the receiving system. The WDM system 42 transmits the light signals at the appropriate wavelengths and combines the signals for transmission along the optical fiber 40. The WDMs 24 of the module 20 perform similar functions.

The module 20 may be an independent enclosure or may be contained within an enclosure including additional network components, such as an LCP. Specifications of the remotely-pumped the erbium coil 22 typically include: C-bandwidth amplification (dependent on number of channels); a length from about 5 to 15 m; an optical input from 9 to 13.5 dBm (assuming 15 dBm Pin, 1 dB connector loss, 1.25 to 5); gain from 3 to 13 dB (constant gain); gain tilt maximum of 0.5 dB/nm (for CSO<−59); and, noise from 5.0 to 6.7 dB (<0.5 dB ΔCNR with 6.75 dB). The remotely-pumped erbium coil 22 provides outside-plant amplification without outside-plant electrical powering. The wavelengths originating from the one or more 1480 nm pumps 46 remotely excite the erbium coil 22, thus energizing the erbium coil 22 and energizing the transmission signals. The energy does not propagate beyond the LCP splitter, but is used to amplify the signal for increased splitting at the LCP. Stimulated Brillouin scattering (SBS) impairs the fidelity of a signal at 1550 nm, but does not at 1480 nm. A power output of about 63 to about 100 mW is preferred for a 20 km network, but may vary based on the length of the network and the number of splits. In an alternative embodiment, a conventional network having 1×4, 1×8 or 1×16 splitting in the LCP may benefit from the principles of the present invention by using an erbium coil and a lower power laser diode to supply power to the same number of subscribers.

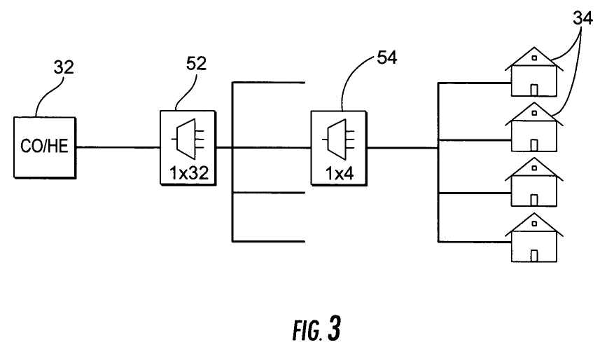

Referring now to FIG. 2, a block diagram illustrating an FTTx PON including a 1480 nm remotely-located pump 46 at the CO/head end 32 and the erbium coil 22 located upstream of the LCP splitter 52 is shown. The digital downstream and digital upstream signals in the embodiment shown have been shifted from the FSAN standard to the C-band window. The system WDM 42 is positioned downstream of the CO/head end 32. The module 20 including the erbium coil 22 and in some embodiments, the pair of WDMs is disposed between the system WDM 42 and the LCP 52. One or more network access points (NAPs) 54 are positioned at predetermined locations downstream of the LCP 52 and provide multiple dedicated drops to a plurality of subscriber premises 54. The remotely-pumped erbium coil 22 of the present invention allows a greater number of subscriber premises 34 to be included within a single optical network and at a greater distance from the CO/head end 32 as compared to conventional PONs that do not include a remotely-pumped erbium coil 22.

The first split point in the network may be co-located with the module 20, but must occur downstream of the erbium coil 22 and signal amplification in order to provide the increased split rate. In preferred embodiments, the module 20 is located immediately before the LCP 52 and splitting occurs at an LCP splitter capable of performing 1×32 splitting. The LCP is the first split point downstream of the CO/head end 32 and is located at a predetermined distance from the CO/HE 32 and the one or more NAPs 54. Preferably, the erbium coil 22 is located at the point in the network at which the signal levels, particularly the analog signal level, do not drop down to approximately the noise level, a point at which the erbium coil 22 may not be able to distinguish between the noise and the signal. Gain provided by the erbium coil 22 adds to the power budget allowing increased loss from increased splitting and/or increased network reach.

Referring to FIG. 3, a block diagram illustrating an exemplary FTTx PON with 128 total splits and a 20 km reach where a remotely-pumped erbium coil 22 is placed immediately before an LCP splitter 52 is shown. The erbium coil 22 allows for an increased network reach and/or increased split rate at the first split point in a PON. In preferred embodiments, the FTTx PON provides 1×32 splitting at the LCP splitter 52 and 1×4 splitting at the NAPs 54, providing 128 total splits and about a 20 km network reach. In contrast, conventional PONs provide 1×4, 1×8 or 1×16 splitting at the LCP and 1×4 splitting at the Network Access Points (NAPs) for a total split rate of 32 and up to a 20 km reach, but not both together. In the exemplary FTTx PON shown, the distance between the CO/head end 32 may range from about 0 to 18 km, the distance from the LCP 52 to the individual NAPs 54 may range from about 0 to 4 km, and the dedicated drops from the NAPs 54 to the subscriber premises 34 may range from about 0 to 500 ft, for a total network reach of around 20 km.

Conventional PONs launch a nearly SBS-limited signal power at the CO/head end to maximize the analog signal power budget. Remote amplification allows the signal power to drop in the outside fiber plant before gain is added, typically just before the splitter. The gain adds to the power budget allowing increased loss from more optical splitting, more fiber or more connectors. Using existing network architecture and cost of components, increased optical splitting provides large cost savings by splitting the cost of expensive components over a greater number of subscribers.

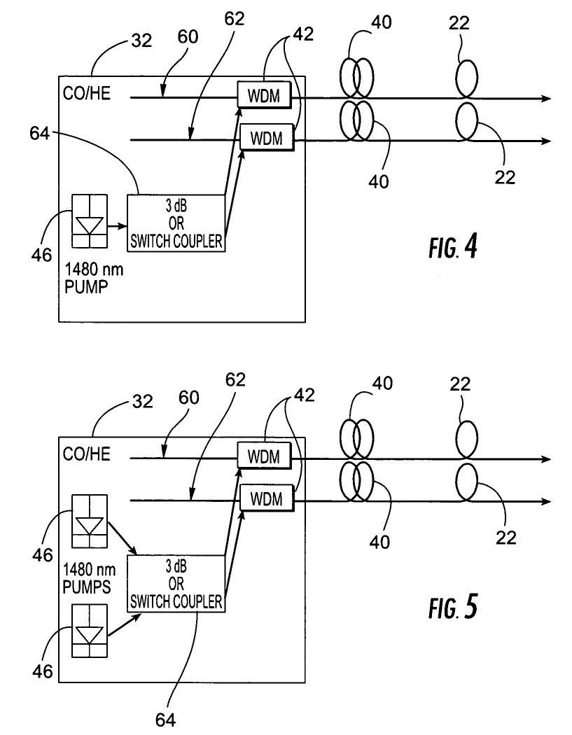

Referring to FIG. 4, a block diagram illustrating a pump-sharing configuration in which a single high power pump laser diode 46 is split between two PONs 60, 62 is shown. A 3 dB tap coupler or switch coupler 64 may be used to provide adjustable gain, a useful feature if PON loss is unequal from a difference in fiber distance, split ratio, number of connections, or other reason. This is especially useful in NAPs with two fiber outputs so that a single pump controls each NAP. As shown, the erbium coil 22 is positioned within each PON after the CO/head end 32 but before the LCP 52. Referring to FIG. 5, a block diagram illustrating an alternative embodiment of a pump sharing configuration in which two lower power pump laser diodes 46 are shared between two PONs 60, 62 is shown. The main benefit with this configuration is increased reliability in case of pump failure. The pump(s) 46 are used to drive the amplifying erbium coil 22 in the digital/analog path. In the two pump 46 configuration, both of the lasers may drive the erbium coil 22 in the digital/analog path. In both configurations, the pump laser diode(s) 46 drives the erbium coil 22 via the switch coupler 64 and respective WDM devices 42. With respect to either pump configuration, the gain or output power to each of the PONs 60, 62 can be controlled independently.

For PON simplification and greatest cost savings, all signals should be amplified by the same erbium coil. Conventional networks use semiconductor optical amplifiers (SOAs) for non-1550 nm signals. The present invention shifts those signals into the erbium amplification band. A separation of 20 nm between the analog and digital downstream minimizes costs by relaxing transmitter center wavelength tolerance and demultiplexing filter design. As stated above, the current FSAN standard specifies 1550 to 1560 nm for the analog downstream, leaving 1570 to 1580 nm or 1530 to 1540 nm for the digital downstream. While either may be practiced, the 1570 to 1580 nm range avoids the desirability of using a strong GFF for the about 1534 nm erbium emission peak, whereas the 1530 to 1540 nm range retains all transmitted signals within the C-band for a desirable pump efficiency and noise figure. The 10 nm band immediately adjacent to the analog signal (either 1540 to 1550 nm or 1560 to 1570 nm) may be designated for the digital upstream. The wide bandwidth also promotes the use of lower cost transmitters. Still further, a final option is to start just to the long wavelength side of the erbium emission peak and tighten the guard bands enough to remain in the C-band, e.g.,about 1536 to 1566 nm.

The primary advantage of amplifying all signals with a single erbium coil prior to the first split point is boosting signal strength for increased splitting, thus sharing costs among a greater number of subscribers and increasing the number of subscribers provided by a single network. Remote amplification of an erbium coil increases the total split rate to 1×128, up from 1×16 for subscribers out to 8 km from the CO/head end, and 1×32 for subscribers between about 8 to 20 km from the CO/head end in conventional architectures. The desired additional gain is easily achieved with a remotely pumped erbium coil. The erbium coil amplifies signals transmitted in the C-band. Specifically, the remotely-located pump energizes the erbium coil, which energizes the signals that pass through the coil. The coil amplifies all signals, and increases the analog signal to compensate for the loss budget of the analog signal that is approximately 3 dB worse than that of the digital signals. The loss budget for the analog signal is substantially equalized to that of the digital signals by gain provided by the erbium coil. Any future upgraded transmitter speed increase could be accommodated by an upgrade of the amplifier gain.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An apparatus for multiple signal amplification in a passive optical network, comprising:
a remotely-pumped, single erbium coil positioned intermediate a central office and a split point in the network;
wherein both analog and digital signals transmitted within an erbium coil amplification band from the central office and one or more subscriber premises pass through the erbium coil and are amplified prior to being split at the split point.

2. The apparatus according to claim 1, wherein the erbium amplification band is from about 1530 to 1562 nm.

3. The apparatus according to claim 1, further comprising a first bandpass optical filter positioned at an input end of the apparatus, and a second bandpass optical filter positioned at an output end of the apparatus, wherein the first and second bandpass optical filters are operable for redirecting a digital upstream signal through an alternate path within the apparatus and bypassing the erbium coil.

4. The apparatus according to claim 3, further comprising a gain-flattening filter.

5. The apparatus according to claim 3, further comprising an isolator operable for protecting the erbium coil from reflections from subscriber premise equipment.

6. The apparatus according to claim 1, wherein a 1480 nm pump co-located with the central office energizes the erbium coil.

7. The apparatus according to claim 1, wherein an analog downstream signal is transmitted at 1550 to 1560 nm, a digital downstream signal is transmitted at 1530 to 1540 nm, and a digital upstream signal is transmitted at either 1540 to 1550 nm or 1560 to 1570 nm.

8. The apparatus according to claim 1, wherein an analog downstream signal is transmitted at 1550 to 1560 nm, a digital downstream signal is transmitted at 1570 to 1580 nm, and a digital upstream signal is transmitted at either 1540 to 1550 nm or 1560 to 1570 nm.

9. The apparatus according to claim 1, wherein the remotely pumped erbium coil amplifies the multiple signals such that 1×32 splitting occurs at a first split point in the network and 1×4 splitting occurs at a plurality of network access points downstream of the first split point for a combined split total of 128 splits.

10. A passive optical network, comprising:
a central office/head end for transmitting analog and digital signals;
a local convergence point providing a first split point in the passive optical network for splitting the analog and digital signals;
an amplification apparatus positioned intermediate the central office and the local convergence point, the apparatus including a remotely-pumped erbium coil;
one or more network access points; and
a plurality of subscriber premises;
wherein both the analog and digital signals pass through the remotely-pumped erbium coil before passing through the local convergence point.

11. The passive optical network according to claim 10, wherein the erbium coil amplifies at a band from 1530 to 1562 nm.

12. The passive optical network according to claim 10, wherein the amplification apparatus further includes a first bandpass optical filter positioned at an input end of the apparatus, and a second bandpass optical filter positioned at an output end of the apparatus, wherein the first and second bandpass optical filters are operable for redirecting a digital upstream signal through an alternate path within the apparatus and bypassing the erbium coil.

13. The passive optical network according to claim 12, further comprising a gain-flattening filter and an isolator operable for protecting the erbium coil from reflections from subscriber premise equipment.

14. The passive optical network according to claim 10, wherein a 1480 nm pump co-located with the central office energizes the erbium coil.

15. The passive optical network according to claim 10, wherein an analog downstream signal is transmitted at 1550 to 1560 nm, a digital downstream signal is transmitted at 1530 to 1540 nm, and a digital upstream signal is transmitted at either 1540 to 1550 nm or 1560 to 1570 nm.

16. The passive optical network according to claim 10, wherein an analog downstream signal is transmitted at 1550 to 1560 nm, a digital downstream signal is transmitted at 1570 to 1580 nm, and a digital upstream signal is transmitted at either 1540 to 1550 nm or 1560 to 1570 nm.

17. The passive optical network according to claim 10, wherein the remotely pumped erbium coil amplifies the analog and digital signals such that 1×32 splitting occurs at the local convergence point and 1×4 splitting occurs at the one or more network access points for a total of 128 splits.

18. A method of amplifying analog and digital signals within a passive optical network prior to a first split point within the network, comprising:
passing the analog and digital signals transmitted through at least one passive amplification element positioned intermediate a central office and a first split point in the network.

19. The method according to claim 18, further comprising passing analog and digital downstream signals through an erbium coil and passing a digital upstream signal through the apparatus containing a first bandpass optical filter positioned at an input end of the apparatus, and a second bandpass optical filter positioned at an output end of the apparatus, wherein the first and second bandpass optical filters are operable for redirecting the digital upstream signal through an alternate path within the apparatus and bypassing the erbium coil.

20. The method according to claim 18, wherein the erbium amplification band is from 1530 to 1562 nm, a digital downstream signal is transmitted at either 1530 to 1540 nm or 1570 to 1580 nm, and a digital upstream signal is transmitted at either 1540 to 1550 nm or 1560 to 1570 nm.
